(19) United States
(12) Patent Application Publication
(10) Pub. No.: US 2016/0047186 A1
(43) Pub. Date: Feb. 18, 2016

(54) METHOD AND APPARATUS FOR COATING A SCREEN

(71) Applicant: M-I L.L.C., Houston, TX (US)

(72) Inventors: Eric Cady, Walton, KY (US); Bradley Jones, Crestview Hills, KY (US)

(21) Appl. No.: 14/783,871

(22) PCT Filed: Apr. 11, 2014
(86) PCT No.: PCT/US2014/033787

§ 371 Date: Oct. 12, 2015

Related U.S. Application Data
(60) Provisional application No. 61/811,237, filed on Apr. 12, 2013.

(51) Int. Cl. E21B 21/06; B07B 1/46; B01D 39/12

(52) U.S. Cl. CPC E21B 21/065; B01D 39/12; B07B 1/4618

(57) ABSTRACT

A coated screen has a screen frame. A screen mesh having a top surface and a bottom surface may be attached to the upper side of the screen frame and may extend the length and the width of the screen frame. A surface of the screen mesh may have a coating. The coating is at least one of hydrophilic, oleophilic, hydrophobic or oleophobic. A method of manufacturing a coated screen includes attaching a mesh to a screen frame. The mesh has a top surface and a bottom surface. A hydrophilic coating may be applied to the top surface of the mesh. A method of coating a screen includes applying a coating to a surface of a screen mesh wherein the coating is at least one of hydrophilic, oleophilic, hydrophobic or oleophobic.

### CROSS-REFERENCE TO RELATED APPLICATIONS

This application claims the benefit of U.S. Provisional Patent Application No. 61/811,237, filed 12 Apr. 2013 (12/04/2013), the disclosure of which is incorporated herein by reference.

### BACKGROUND OF THE INVENTION

In certain industries and/or applications, separating one material from a second material is often desired and/or required. Further, the separation of solids and fluids is generally known in a variety of industries and/or applications. For example, the mining industry has many applications in which solids may be separated from fluids to extract a desired ore and/or metal during mining processes. Further, on-shore and/or off-shore drilling applications use various methods and/or equipment to separate solids from fluids in drilling processes.

For example, drilling fluids or muds are commonly circulated in the well during such drilling to cool and lubricate the drilling apparatus, lift drilling cuttings out of the wellbore, and counterbalance the subterranean formation pressure encountered. The recirculation of the drilling mud requires the fast and efficient removal of the drilling cuttings and other entrained solids from the drilling mud prior to reuse.

Apparatus to remove cuttings and other solid particulates from drilling fluid are commonly referred to as “shale shakers.” A shale shaker, also known as a vibratory separator, may be used to filter cuttings and other solid particulates from oilfield drilling fluid, often called “mud.” Typically, the shale shaker may be an angled table with a generally perforated filter screen bottom. As the drilling mud travels down the incline toward the lower end, the fluid falls through the perforations to a reservoir below thereby leaving the solid particulate material behind. The combination of the angle of inclination with the vibrating action of the shale shaker table enables the solid particles left behind to flow until they fall off the lower end of the shaker table.

Screens used with shale shakers may be placed on a horizontal bed or support within a basket in the shaker. The screens themselves may be flat, corrugated, depressed, or contain raised surfaces. The shale shaker may impart a rapidly reciprocating motion to the basket and the screens. The mud may be poured onto a back end of the vibrating screen, flowing toward the discharge end of the basket. Large particles that are unable to move through the screen remain on top of the screen and move toward the discharge end of the basket where they are collected. The smaller particles and fluid may flow through the screen and collect in a bed, receptacle, sump or pan beneath the screen.

In some shale shakers a fine screen cloth may be used with the vibrating screen. The screen may have two or more overlaying layers of screen cloth or mesh. Layers of cloth or mesh may be bonded together and placed over a support or a perforated plate. The frame of the vibrating screen may be resiliently suspended or mounted upon a support and may be caused to vibrate by a vibrating mechanism. Each screen may be vibrated by vibratory equipment to create a flow of trapped solids on top surfaces of the screen for removal and disposal of solids. The fineness or coarseness of the mesh of a screen may vary depending upon mud flow rate and the size of the solids to be removed.

While there are numerous styles and sizes of filter screens, they generally follow similar design. Typically, filter screens may include a perforated plate base upon which a wire mesh, or other perforated filter overlay, may be positioned. The perforated plate base may provide structural support and allow the passage of fluids therethrough, while the wire mesh overlay may define the largest solid particle capable of passing therethrough.

Screens may be provided in different types. For example, Burnett et al. disclose in U.S. Patent Publication No. US 2006/0180509 A1 that screens are generally of one of two types, namely hook-strip and pre-tensioned. The hook-strip type of screen may have several rectangular layers of mesh in a sandwich and may have one or two layers of fine grade mesh and a supporting mesh having larger mesh holes and heavier gauge wire. The layers of mesh may be joined at each side edge by a strip which may be in the form of an elongate hook. In use, the elongate hook may be hooked on to a tensioning device arranged along each side of a shale shaker, over which the layers of mesh are tensioned.

One example of a hook-strip type of screen of a shaker screen frame is disclosed by Carr et al. in U.S. Pat. No. 7,992,719, assigned to the assignee of the present application, and incorporated herein by reference in its entirety.

The pre-tensioned type of screen may have several rectangular layers of mesh and may have one or two layers of fine grade mesh and a supporting mesh having larger mesh holes and heavier gauge wire. The layers of mesh may be pre-tensioned on a rigid support, possibly a rectangular angle iron frame and adhered thereto. The screen may then be inserted into C-channel rails arranged in a basket of a shale shaker. Various attempts to improve the overall operation of shakers have been made. For example, the shaker screen may be improved operationally by coating the screen with a “slick” polymeric substance so that gummy or sticky materials may be less likely to adhere to the screen surface.

As a result, there exists a continuing need for shakers having increased fluid capacity, increased fluid flow-through rates across the screens, and/or improved fluid removal efficiencies. Accordingly, there exists a need for screens with improved fluid capacity.

Preferably, the means used to increase the fluid capacity of the screen also enhances the flow of solids across the screen.

Additionally, there exists a need for a shaker screen that causes the fluid to exit the screen faster after the fluid has passed through the pores in the filter mesh. Further, there exists a need for a shaker screen that draws the fluid to the screen and after the fluid has passed through the pores in the filter mesh, the shaker vibration may cause the fluid to fall.

### BRIEF DESCRIPTION OF DRAWINGS

FIG. 1a is an exploded perspective view of a cross-section of a screen in an embodiment disclosed herein.

FIG. 1b is an exploded side view of a screen in an embodiment disclosed herein.

FIG. 2 is a side view of a portion of a screen in an embodiment disclosed herein.

FIG. 3 is a side view of a portion of a screen in an embodiment disclosed herein.

FIG. 4 is a side view of a portion of a screen in an embodiment disclosed herein.

### DETAILED DESCRIPTION OF THE PREFERRED EMBODIMENTS

Embodiments disclosed herein relate generally to screens for use as filters in vibratory filtration equipment such as shakers. Specifically, embodiments disclosed herein relate to methods and apparatus for coating a screen.

In one aspect, embodiments disclosed herein relate to a coated screen. The coated screen may include, in some embodiments, a screen frame having a length and a width. A screen mesh having a top surface and a bottom surface may be attached to the upper side of the screen frame and may extend the length and the width of the screen frame. A surface of the screen mesh may have a coating. The coating may be at least one of hydrophilic, oleophilic, hydrophobic or oleophobic. In some embodiments, the coated screen may have a hydrophilic and/or oleophilic coating on the top surface of the screen mesh. In other embodiments, the coated screen may have a hydrophobic and/or oleophobic coating on the bottom surface of the screen mesh. In further embodiments, the coated screen may have a hydrophilic and/or oleophilic coating on the top surface of the screen mesh and a hydrophobic and/or oleophobic coating on the bottom surface of the screen mesh.

In other aspects, embodiments disclosed herein relate to a method of manufacturing a coated screen. A mesh may be attached to a screen frame. The mesh may have a top surface and a bottom surface. A hydrophilic coating may be applied to the top surface of the mesh. In further aspects, embodiments disclosed herein relate to a method of coating a screen. A coating may be applied to a surface of a screen mesh wherein the coating may be at least one of hydrophilic, oleophilic, hydrophobic or oleophobic.

A typical oilfield screen may have a screen frame and one or more layers of stainless steel screen mesh. One example of a shaker screen frame is disclosed by Riddle in U.S. Pat. No. 7,210,582, assigned to the assignee of the present application, and incorporated herein by reference in its entirety.

Further, one having ordinary skill in the art should understand and appreciate that a wide variety of materials may be utilized for the construction of the frame. In one such embodiment, the frame may be constructed of welded metal, such as steel, steel alloys, aluminum, aluminum alloys, and the like which may subsequently be coated with paint, epoxy, thermoplastic and other such protective materials.

Alternatively, the frame may be constructed from composite materials including resin based composites, such as fiberglass/resin; carbon fiber/resin; metal fiber/resin; combinations of these and the like, thermoplastic composites such as fiberglass/plastic; carbon fiber/plastic; metal fiber/plastic; combinations of these and the like; as well as combinations of various composite materials that are suitable for such applications. Finally, one having ordinary skill in the art would appreciate that the illustrative frames may be cast, stamped, forged, or machined from ferrous and non-ferrous metals, plastics, composite materials and the like.

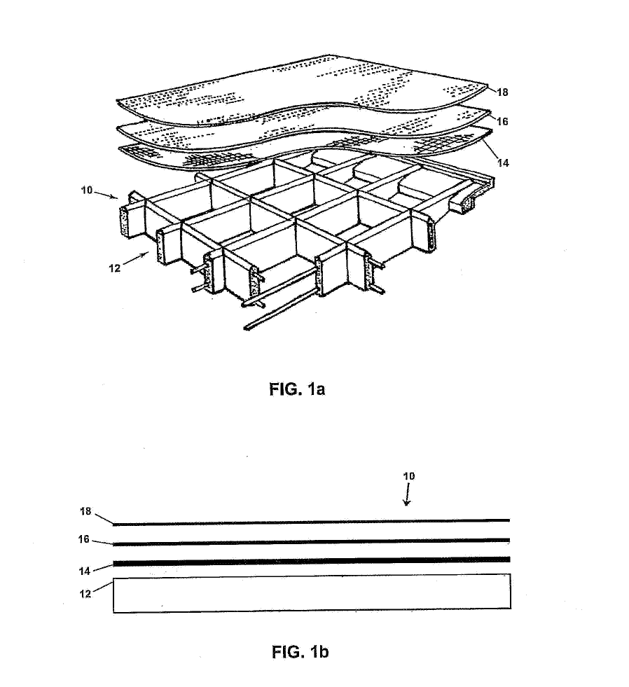

Turning now to the drawings, FIG. 1a illustrates an embodiment of a screen 10. As shown, the screen 10 may have a screen frame 12. The screen 10 may have multiple layers of screen mesh. In the embodiment illustrated in FIG. 1a, the screen 10 has a bottom layer 14 of screen mesh, a middle layer 16 of screen mesh and a top layer 18 of screen mesh. The screen mesh may be constructed of any material capable of providing desired performance and reliability requirements sufficient for operation in a harsh environment.

Screens may be constructed from sheets of woven wire mesh stretched over and secured to metal frames using a polymer adhesive. An example of such a screen is disclosed by Robertson in U.S. Patent Application Publication No. 2010/0219110 A1, assigned to the assignee of the present application, and incorporated herein by reference in its entirety. Typically, the frames may be generally rectangular and may define one or more rectangular openings over which the wire mesh may be stretched.

In an embodiment, two or more layers of wire mesh having different mesh sizes may be secured to each metal frame. The tensions in the warp and weft wires of one mesh may normally be greater than the corresponding warp and weft wire tensions in the other mesh. Additionally, multiple screens 10 may be employed in any one shaker.

In a typical shaker, a sump (not shown) may be located below the screen 10 to receive material passed through the screen 10. Material not passing through the screen 10 may be discharged off the end of the screen 10 and suitably collected. The flow across the screen 10 from an inlet toward an outlet of the shaker defines a linear direction of material travel.

To increase the throughput of fluid through the screen mesh, a pressure differential device (not shown) may be provided to create a pressure differential between the vapor space above the screen 10 and the vapor space below the screen 10 and the sump. The pressure differential device may be located internal to the sump, such as an air pump (not shown). In other embodiments, the pressure differential device may be located external to the sump, such as a vacuum system (not shown). Whether internal or external to the sump, the pressure differential device may cause vapor to flow from the vapor space between the screen 10 and the sump to a point external to the sump, such as through an outlet or other conduits forming an outlet from the sump.

As an alternative, or in addition to, the features to further increase the throughput of fluid through the screen mesh, a coating may be applied to one or more layers of the screen mesh. A coating that is hydrophilic may draw water-based fluids into the mesh. A coating that is oleophilic may draw oil-based fluids into the mesh. A coating with both properties may be ideal for oilfield applications where drilling fluids are either water-based or oil-based.

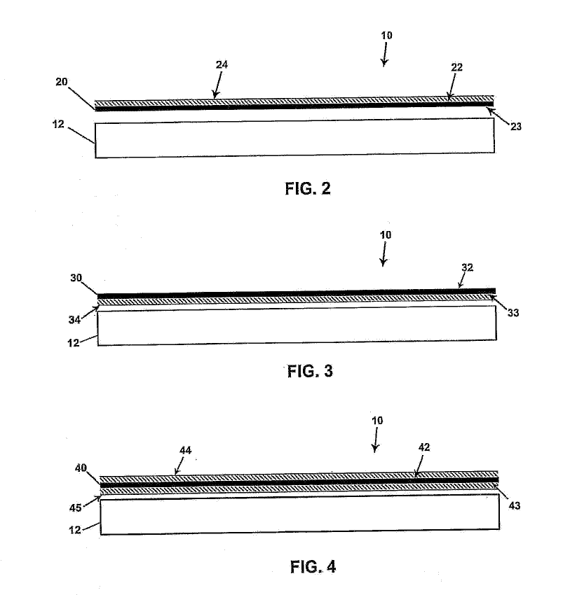

FIG. 2 is a side view of a portion of the screen 10 in an embodiment disclosed herein. FIG. 2 illustrates a layer of screen mesh 20. The mesh 20 has a top surface and a bottom surface 23. In this illustrated embodiment, the top surface 22 of the mesh 20 may be coated with a hydrophilic and/or oleophilic coating 24. Applying the hydrophilic and/or oleophilic coating 24 to the top surface 22 of the mesh 20 may draw fluid onto the screen mesh 20. After the fluid passes through the pores in the mesh 20, the shaker vibration may cause the fluid to fall through the mesh 20. In this embodiment, the top surface 22 may be coated, and the bottom surface 23 may not be coated. By not coating the bottom surface 23, the fluid may be less likely to be drawn to the underside of the mesh 20 and therefore less likely to adhere to the bottom surface 23 of the mesh 20.

In another embodiment, FIG. 3 illustrates a side view of a portion of a screen 10. FIG. 3 illustrates a layer of screen mesh 30 having a top surface 32 and a bottom surface 33. In this illustrated embodiment, the bottom surface 33 of the mesh 30 may be coated with a hydrophobic and/or oleophobic coating 34. The hydrophobic and/or oleophobic coating 34 may be a coating that repels water and oil, respectively. Applying the hydrophobic and/or oleophobic coating 34 to the bottom surface 33 of the mesh 30 may cause the fluid to exit the screen faster after the fluid has passed through the pores in the screen mesh 30.

FIG. 4 is a side view of a portion of a screen in an embodiment disclosed herein. FIG. 4 illustrates a layer of screen mesh 40 having a top surface 42 and a bottom surface 43. In this illustrated embodiment, the top surface 42 of the mesh 40 may be coated with a hydrophilic coating 44. Applying the hydrophilic coating 44 to the top surface 42 of the mesh 40 may draw fluid onto the screen. After the fluid passes through the pores in the mesh 40, the shaker vibration may cause the fluid to fall through the mesh 40. Also, the bottom surface 43 of the mesh 40 may be coated with a hydrophobic coating 45. Applying the hydrophobic coating 45 to the bottom surface 43 of the mesh 40 may cause the fluid to exit the screen faster after the fluid has passed through the pores in the screen mesh 40.

In a further embodiment, the hydrophilic coating 44 may also be oleophilic. Similarly, the bottom surface 43 may be coated with a hydrophobic coating 45. In an embodiment, the hydrophobic coating 45 may also be oleophobic. The combination of coatings having properties of attraction of both oil-based fluids and water-based fluids may promote fluid flow into the top surface 42 of the screen mesh 40. Similarly, the combination of coatings having properties of repulsion of both oil-based fluids and water-based fluids may promote fluid flow away from the bottom surface 43 of the screen mesh 40. In this embodiment, the mesh 40 may act as a pump by increasing fluid flow through the screen compared to flow caused by gravity and vibration alone.

Advantageously, embodiments disclosed herein may provide shaker screens having increased fluid capacity, increased fluid flow-through rates across the screens, and/or improved fluid removal efficiencies. Since the fluids may be water-based and/or oil-based, each of the embodiments may have coatings on the top surface and/or the bottom surface of the screen mesh that may be hydrophilic and/or oleophilic as well as hydrophobic and/or oleophobic as appropriate in view of the disclosure. Also, the coatings applied to the mesh may increase abrasion resistance to the mesh and therefore increase the life of the screen. Further, the coatings, especially a “phobic” coating, may repel the fluid and may prevent the fluid from coming into contact with the screen mesh to reduce friction. The “phobic” coatings may repel the fluid to reduce loading and/or to reduce fatigue on the mesh to increase screen life.

Thus, in an aspect of the invention, a coated screen is disclosed. The coated screen may have a screen frame. A screen mesh having a top surface and a bottom surface may be attached to the upper side of the screen frame and may extend the length and the width of the screen frame. A surface of the screen mesh may have a coating. The coating may be at least one of hydrophilic, oleophilic, hydrophobic or oleophobic.

In some embodiments, the coated screen may have a hydrophilic and/or oleophilic coating on the top surface of the screen mesh. In other embodiments, the coated screen may have a hydrophobic and/or oleophobic coating on the bottom surface of the screen mesh. In further embodiments, the coated screen may have a hydrophilic and/or oleophilic coating on the top surface of the screen mesh and a hydrophobic and/or oleophobic coating on the bottom surface of the screen mesh.

In another aspect, embodiments disclosed herein relate to a method of manufacturing a coated screen. A mesh may be attached to a screen frame. The mesh may have a top surface and a bottom surface. A hydrophilic coating may be applied to the top surface of the mesh.

In a further aspect, embodiments disclosed herein relate to a method of coating a screen. A first coating may be applied to a first surface of a screen mesh. The first coating may be at least one of hydrophilic or oleophilic. A second coating may be applied to a second surface of the screen mesh. The second coating may be at least one of hydrophobic or oleophobic.

Surface coatings may be applied to a screen mesh to provide a method of increasing the fluid capacity of a screen. Further, the method may increase abrasion resistance to the mesh and may therefore increase the life of the screen. The coating, especially a “phobic” coating, may repel the fluid and may prevent the fluid from coming into contact with the screen mesh to reduce friction. Also, the coating may repel fluid to reduce loading and/or to reduce fatigue on the mesh. Thus, the coating may increase screen life.

Those having ordinary skill in the art will appreciate that other embodiments may be devised which do not depart from the scope of the disclosure as described herein. Accordingly, the scope of the present disclosure should be limited only by the attached claims.

1. A method comprising:
attaching a mesh to a frame wherein the mesh has a top surface and a bottom surface wherein the bottom surface is located in a position opposite to the top surface; and
applying a coating on at least one of the bottom surface of the mesh or the top surface of the mesh wherein the coating either attracts or repels fluids.

2. The method of claim 1 further comprising:
applying a hydrophilic coating to the top surface of the mesh.

3. The method of claim 1 further comprising:
applying a hydrophobic coating to the bottom surface of the mesh.

4. The method of claim 1 further comprising:
applying an oleophilic coating to the top surface of the mesh.

5. The method of claim 1 further comprising:
applying an oleophobic coating to the bottom surface of the mesh.

6. The method of claim 1 further comprising:
attaching a plurality of layers of mesh to the frame wherein a coating is applied to one of the layers of mesh.

7. The method of claim 1 further comprising:
attaching a plurality of layers of mesh to the frame wherein each of the layers of mesh has a coating wherein the coating is at least one of hydrophilic, oleophilic, hydrophobic or oleophobic.

8. The method of claim 1 further comprising:
attracting oil-based fluids or water-based fluids to promote fluid flow into the top surface of the mesh.

9. The method of claim 1 further comprising:
repelling oil-based fluids or water-based fluids to promote fluid flow away from the bottom surface of the mesh.

10. The method of claim 1 further comprising:
applying a combination of coatings having properties of attraction of oil-based fluids or water-based fluids to promote fluid flow into the top surface of the mesh.

11. The method of claim 1 further comprising:
applying a combination of coatings having properties of repulsion of oil-based fluids or water-based fluids to promote fluid flow away from the bottom surface of the mesh.

12. A coated screen comprising:
a screen frame having a length and a width and an upper side and a lower side wherein the lower side is located in a position opposite to the upper side;
a screen mesh having a top surface and a bottom surface wherein the bottom surface is located in a position opposite to the top surface and further wherein the screen mesh is attached to the upper side of the screen frame and extends the length and the width of the screen frame; and
a coating located on at least one of the bottom surface of the screen mesh or the top surface of the screen mesh wherein the coating either attracts or repels fluids.

13. The screen of claim 12 further comprising:
a hydrophilic coating on the top surface of the screen mesh.

14. The screen of claim 12 further comprising:
a hydrophobic coating on the bottom surface of the screen mesh.

15. The screen of claim 12 further comprising:
an oleophilic coating on the top surface of the screen mesh.

16. The screen of claim 12 further comprising:
an oleophobic coating on the bottom surface of the screen mesh.

17. The screen of claim 12 further comprising:
a hydrophilic coating on the top surface of the screen mesh and a hydrophobic coating on the bottom surface of the screen mesh.

18. The screen of claim 12 further comprising:
a coating on the top surface of the screen mesh wherein the coating is hydrophilic and oleophilic and a coating on the bottom surface of the screen mesh wherein the coating is hydrophobic and oleophobic.

19. A method comprising:
providing a screen mesh having a first surface and a second surface wherein the second surface is located in a position opposite to the first surface;
applying a first coating to the first surface of the screen mesh wherein the first coating is at least one of hydrophilic or oleophilic; and
applying a second coating to the second surface of the screen mesh wherein the second coating is a least one of hydrophobic or oleophobic.

20. The method of claim 19 further comprising:
providing a plurality of layers of screen mesh wherein each of the layers of screen mesh has a coating wherein the coating is at least one of hydrophilic, oleophilic, hydrophobic or oleophobic.
